(19) United States
(12) Patent Application Publication
(10) Pub. No.: US 2025/0333087 A1
(43) Pub. Date: Oct. 30, 2025

(54) OPERATING SYSTEM FOR MULTIPLE BATTERY SYSTEMS

(71) Applicant: STEWART & STEVENSON LLC, Houston, TX (US)

(72) Inventors: Mike WARHUS, Houston, TX (US); John LUND, Houston, TX (US); Charles EKE CHUKWU, Houston, TX (US); David ELDRIDGE, Houston, TX (US)

(21) Appl. No.: 19/092,239

(22) Filed: Mar. 27, 2025

Related U.S. Application Data
(60) Provisional application No. 63/637,926, filed on Apr. 24, 2024.

(51) Int. Cl. B61C 17/06; B61C 5/00; B61L 15/00; H01M 10/0525; H01M 10/42; H01M 10/48; H01M 50/249

(52) U.S. Cl. CPC B61C 17/06; B61C 5/00; B61L 15/0081; H01M 10/0525; H01M 10/425; H01M 10/482; H01M 10/486; H01M 50/249; H01M 2010/4278; H01M 2220/20

(57) ABSTRACT

A battery system positioned on a locomotive powered by a diesel engine includes a first battery and a second battery, the first battery and the second battery being lithium-ion batteries, wherein the first battery or the second battery are in electrical connection with a starter of the diesel engine. The first battery and second battery each include a control chassis and a plurality of cells, wherein the plurality of cells are arranged into modules. The battery system also includes a battery control panel, the battery control panel including at least one Human Machine Interface (HMI) and a first switch and a second switch, the first switch in electrical communication with the first battery and a second switch, the second switch in electrical communication with the second battery.

### CROSS-REFERENCE TO RELATED APPLICATIONS

This application is a nonprovisional application which claims priority from U.S. provisional application No. 63/637,926, filed Apr. 24, 2024, which is incorporated by reference herein in its entirety.

### TECHNICAL FIELD/FIELD OF THE DISCLOSURE

The present disclosure relates generally to batteries, specifically operating systems for multiple battery systems.

### BACKGROUND

Electrically-powered equipment, such as that used for diesel locomotive operations, may use batteries to power a hotel load, such as lights and air conditioning, in addition to starting the locomotive diesel engine on the locomotive. Traditionally, the batteries used for diesel locomotive operations are lead acid batteries. Typical measurements regarding a battery on a diesel locomotive supplied to a locomotive operator may be limited to measurements of battery voltage.

### SUMMARY

The present disclosure provides for a battery system positioned on a locomotive powered by a diesel engine. The battery system includes a first battery and a second battery, the first battery and the second battery being lithium-ion batteries, wherein the first battery or the second battery are in electrical connection with a starter of the diesel engine. The first battery and second battery each include a control chassis and a plurality of cells, wherein the plurality of cells are arranged into modules. The battery system also includes a battery control panel, the battery control panel including at least one Human Machine Interface (HMI) and a first switch and a second switch, the first switch in electrical communication with the first battery and a second switch, the second switch in electrical communication with the second battery.

The present disclosure also provides for a method of operating electrical equipment of a locomotive of a diesel engine of a locomotive. The method includes providing a first battery and a second battery, the first battery and the second battery being lithium-ion batteries, wherein the first battery or the second battery are in electrical connection with a starter of the diesel engine. The first battery and second battery each include a control chassis and a plurality of cells, wherein the plurality of cells are arranged into modules. The battery system also includes a battery control panel, the battery control panel including at least one Human Machine Interface (HMI) and a first switch and a second switch, the first switch in electrical communication with the first battery and a second switch, the second switch in electrical communication with the second battery. The method also includes turning on the first switch and the second switch within a pre-determined time and determining whether the first battery is operational. Further, the method includes determining whether the second battery is operational and allowing the first battery and second battery to remain operational if the first battery and the second battery are both operational. In addition, the method includes discontinuing operation of the first battery and the second battery if the second battery is not operational and the pre-determined period of time has lapsed and determining whether the second battery is operational if the pre-determined time period has not lapsed.

### BRIEF DESCRIPTION OF THE DRAWINGS

The present disclosure is best understood from the following detailed description when read with the accompanying figure. It is emphasized that, in accordance with the standard practice in the industry, various features are not drawn to scale. In fact, the dimensions of the various features may be arbitrarily increased or reduced for clarity of discussion.

FIG. 1 is a block diagram of a battery system consistent with certain embodiments of the present disclosure.

FIG. 2 is a block diagram of a battery system in connection with a diesel engine consistent with certain embodiments of the present disclosure.

FIG. 3A is a block diagram showing the controls systems of the batteries of the present disclosure showing two HMIs consistent with certain embodiments of the present disclosure.

FIG. 3B is a block diagram showing the controls systems of the batteries of the present disclosure showing a single HMI consistent with certain embodiments of the present disclosure.

FIG. 4 is a block diagram of a set of control instructions consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

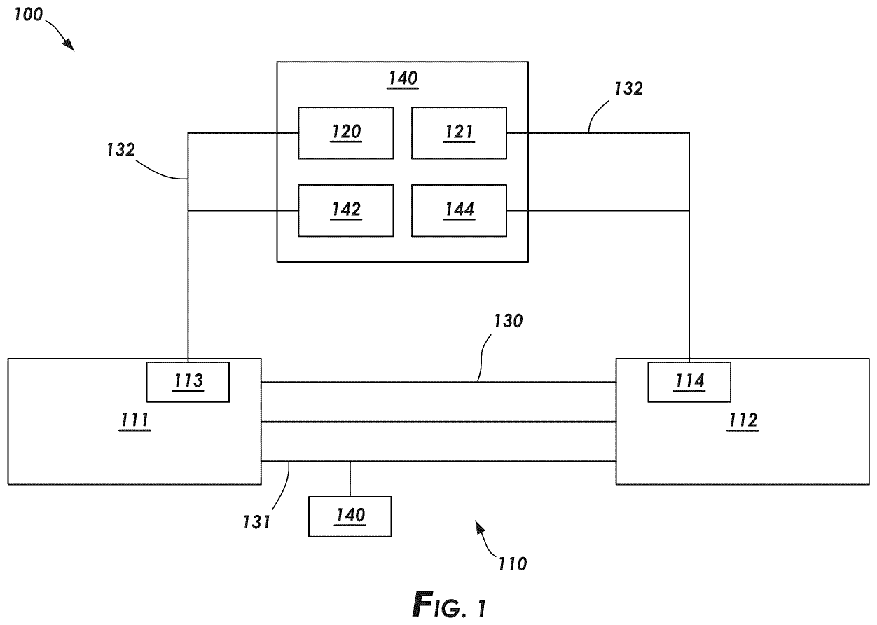

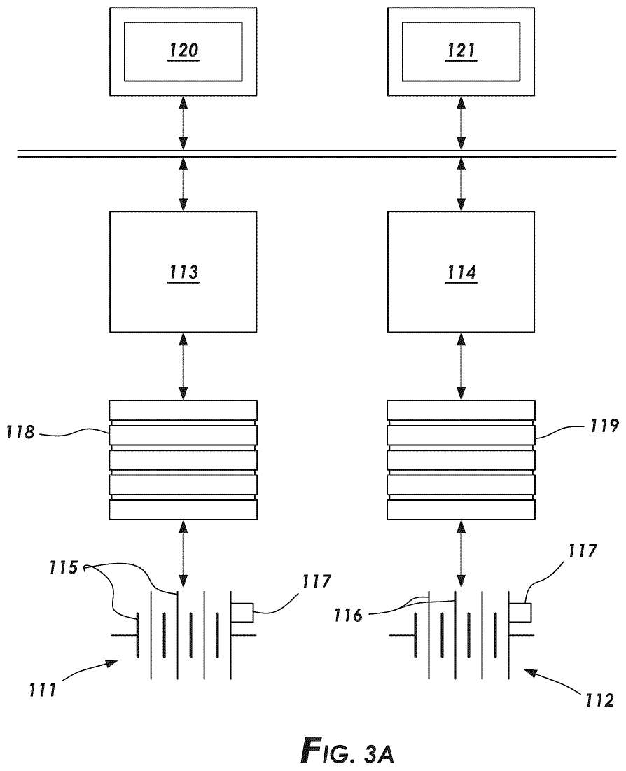

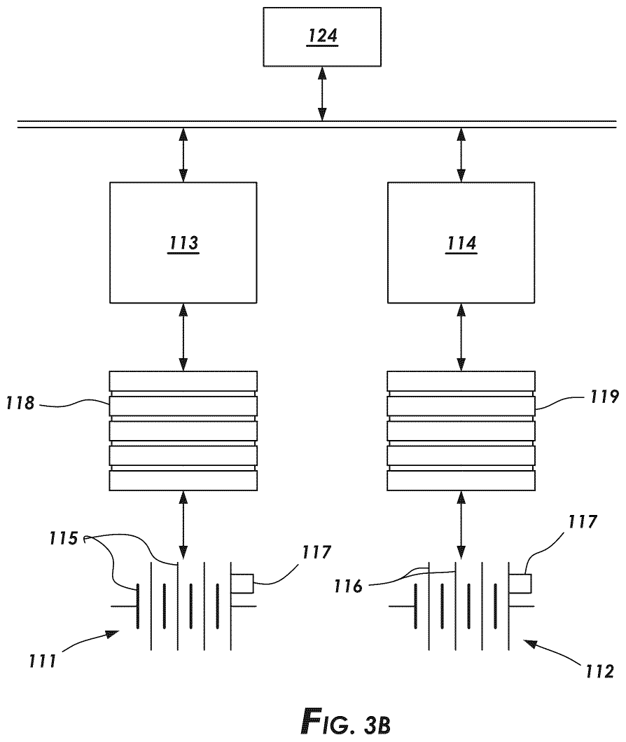

FIG. 1 depicts battery system 100 consistent with certain embodiments of the present disclosure. Battery system 100 includes plurality of batteries 110 (shown as first battery 111 and second battery 112). Although two batteries are shown in FIG. 1, one of ordinary skill in the art with the benefit of this disclosure will understand that plurality of batteries 110 may include two or more batteries. In certain embodiments, batteries 110 are lithium-ion batteries. First battery 111 and second battery 112 may be the same nominal voltage. Each battery has a control chassis, identified as first control chassis 113 for first battery 111 and second control chassis 114 for second battery 112. First control chassis 113 and second control chassis 114 control the operation and measure the conditions of first battery 111 and second battery 112, respectively. For example, first control chassis 113 and second control chassis 114 may, as shown in FIGS. 3A and 3B, monitor individual cells and modules.

As further shown in FIG. 3A, temperature and voltage of individual cells 115 and 116 of first battery 111 and second battery 112 may be monitored by sensors 117. Information gathered by sensors 117 is sent to first module controller 118 and second module controller 119, which correspond to first battery 111 and second battery 112. First module controller 118 and second module controller 119 further manage the operation of individual cells 115, 116. Information gathered by module controllers 118, 119 is sent to first control chassis 113 and second control chassis 114 for control of the modules and to aggregate data for the modules into which batteries 111, 112 are organized. In the embodiment shown in FIG. 3, first battery 111 and second battery 112 are in electronic connection with first Human Machine Interface (HMI) 120 and second HMI 121. HMIs 120, 121 allow an operator to review temperatures and voltage at the battery, module, and cell level and make changes to the operation of first battery 111 and second battery 112. For instance, an operator may see that a battery is operating at a lower voltage than expected and determine which cell or cells is responsible for the lower voltage. Based on this information, the operator, through HMI 120, 121 can make changes to the operation of those batteries. While FIG. 3A depicts a single HMI for each battery, in certain embodiments, as shown in FIG. 3B, single HMI 124 may be used for multiple batteries.

With further attention to FIG. 1, in certain embodiments first battery 111 and second battery 112 are connected by battery power cable 130 to facilitate power transfer between second battery 112 and first battery 111, or vice versa. Battery power cable 130 may carry electricity with high voltages above those of cables carrying low voltage. For example, in certain embodiments, battery power cable 130 may carry electricity with voltages between 12 and 1000 volts. In addition, first control chassis 113 and second control chassis 114 may be connected by battery communications cable. 131. In some embodiments, such as that shown in FIG. 1, communications cable 131 may be in electrical connection with data logger 140. Data logger 140 may be used to remotely display and log data from first battery 111 and second battery 112. Further, first control chassis 113 and second control chassis 114 may be connected to battery control panel 160 through communications and low voltage cables 132. Low voltage cables may carry electricity with voltages between 10 and 50 volts or around 25 volts. Battery control panel 160 may include HMIs 120, 121, or single HMI 124. In addition, battery control panel 160 may include first battery switch 142 and second battery switch 144. Battery switches 142, 144 may be used to start and stop electricity from flowing to an outside load, such as a diesel engine.

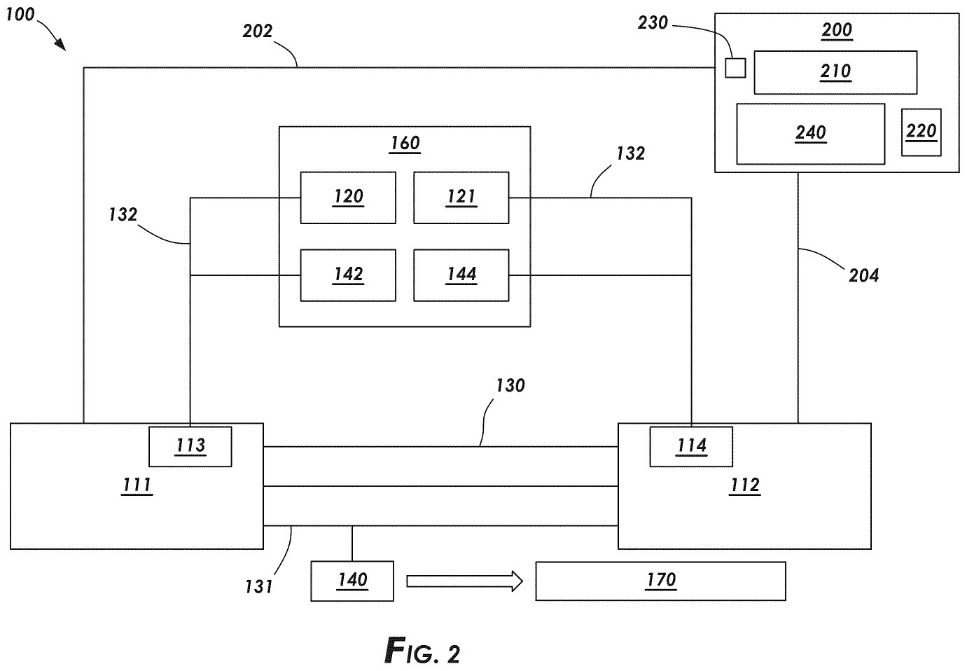

FIG. 2 depicts battery system 100 consistent with certain embodiments of the present disclosure in combination with locomotive 200 as the outside load. Locomotive 200 is driven by diesel engine 210. In certain embodiments, locomotive 200 is not driven by battery system 100 except for jogging operations, as described hereinbelow. Locomotive 200 may also include hotel load 220 and engine starter 230. Locomotive power cable 202 may deliver power to locomotive 200, including hotel load 220 and engine starter 230. In addition, locomotive 200 may include charging system 240. Electricity generated by charging system 240 may be transmitted to first battery 111 or second battery 112 via charging cable 204. In certain embodiments, charging cable 204 is connected to both first battery 111 and second battery 112.

As further shown in FIG. 2, data logger 140 may be in wireless communication with computer/internet 170.

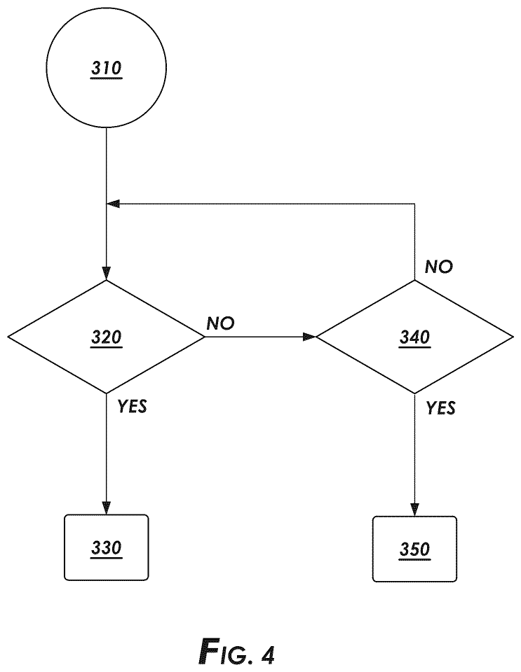

In certain embodiments, battery control panel 160 may include operational instructions to control the operation of first control chassis 113 and second control chassis 114. An embodiment of the operational instructions for battery control panel 160 is shown in FIG. 4. The operator may turn on both first battery 111 and second battery 112 using first battery switch 142 and second battery switch 144. First battery switch 142 and second battery switch 144 may be turned on by the operator within a pre-determined time period of each other, for example, within 60 seconds of each other, or both first battery switch 142 and second battery switch 144 may move to the off position. When the operator turns on both first battery switch 142 and second battery switch 144 within the pre-determined time period, battery control panel 160 may determine whether first battery 111 or second battery 112 are operational. FIG. 4 depicts a circumstance where the first battery 111 is operational in power on side A 310. One of ordinary skill in the art with the benefit of this disclosure will recognize that second battery 112 may be operational in power on side A 310. Battery control panel 160 determines whether second battery 112 is operational in side B power on 320. If both first battery 111 and second battery 112 are operational, both first battery switch 142 and second battery switch 144 remain in the on position as shown in FIG. 4 as ready 330.

Should battery control panel 160 determine that second battery 112 is not operational, battery control panel 160 determines whether the pre-determined time period has elapsed in 60 second elapsed 340. If not, battery control panel 160 determines whether second battery 112 is operational in side b power on 320. If the pre-determined time period has elapsed, battery control panel 160 registers a fault in fault 350. If a fault is registered, both first battery switch 142 and second battery switch 144 are reset to the off position. Thus, in certain embodiments, unless first battery 111 and second battery 112 are operational, no power will flow to locomotive 200. In addition, battery control panel 160 may designate one of batteries 111, 112 as the primary battery. However, if both first battery 111 and second battery 112 are operational, both may supply electricity to locomotive 200. In some embodiments, only the HMI of the primary battery will remain operational if both first battery 111 and second battery 112 are operational. In other embodiments, both HMIs 120, 121 will remain operational. In yet other embodiments, as described above, only single HMI 124 may be present.

In some embodiments, battery control panel 160 may monitor the State of Charge (SOC) of first battery 111 and second battery 112. If the SOC of either battery or both batteries 111, 112 are below a predetermined charge amount, battery control panel 160 may shut off electricity to hotel load 220. By shutting off electricity to hotel load 220 and maintaining the predetermined SOC of batteries 111, 112, engine starter 230 may retain enough charge to start diesel engine 210 on locomotive 200. Further, in some embodiments, compared to traditional lead acid batteries, lithium-ion batteries may support increased jogging operations. Jogging operations are those for moving the locomotive short distances, such as around a shop or yard, without starting the diesel engine, i.e., using battery power to run one of the traction motors on the locomotive. Typically, lead acid batteries will allow only one or two jogging operations without starting the diesel engine, but the lithium-ion batteries will allow as many jogging operations depending on load profile and battery system 100 capacity, for example in the current embodiment battery system 100 can support nine or more jogging operations per day.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A battery system positioned on a locomotive powered by a diesel engine comprising:
a first battery and a second battery, the first battery and the second battery being lithium-ion batteries, wherein the first battery or the second battery are in electrical connection with a starter of the diesel engine, the first battery and second battery each including:
a control chassis;
a plurality of cells, wherein the plurality of cells are arranged into modules; and
a battery control panel, the battery control panel including:
at least one Human Machine Interface (HMI); and
a first switch and a second switch, the first switch in electrical communication with the first battery and a second switch, the second switch in electrical communication with the second battery.

2. The battery system of claim 1, wherein each of the control chassis is adapted to control the respective first battery or second battery.

3. The battery system of claim 2 having a plurality of sensors, the plurality of sensors adapted to measure the temperature and voltage of each cell of the plurality of cells.

4. The battery system of claim 3, wherein the plurality of sensors are in electrical connection with the first control chassis for the first battery and the second control chassis for the second battery.

5. The battery system of claim 4, wherein the at least one HMI includes a first HMI in electrical connection with the first control chassis and a second HMI in electrical connection with the second control chassis.

6. The battery system of claim 5, wherein the at least one HMI consists of a single HMI, wherein the single HMI is in electrical connection with the first control chassis and the second control chassis.

7. The battery system of claim 1, wherein the first battery and the second battery are electrically connected by a battery power cable.

8. The battery system of claim 1, wherein the first battery and second battery are in electrical communication through a battery communications cable.

9. The battery system of claim 1 further comprising a data logger, the data logger in electrical communication with a computer.

10. The battery system of claim 1, wherein the first battery and the second battery are in electrical connection with a hotel load of the locomotive and a charger positioned on the locomotive.

11. The battery system of claim 10, wherein the charger is connected to the first battery of the second battery by a charging cable.

12. A method of operating electrical equipment of a locomotive of a diesel engine of a locomotive, comprising:
providing battery system positioned on a locomotive powered by a diesel engine comprising:
a first battery and a second battery, the first battery and the second battery being lithium-ion batteries, wherein the first battery or the second battery are in electrical connection with a starter of the diesel engine, the first battery and second battery each including:
a control chassis;
a plurality of cells, wherein the plurality of cells are arranged into modules; and
a battery control panel, the battery control panel including:
at least one Human Machine Interface (HMI); and
a first switch and a second switch, the first switch in electrical communication with the first battery and a second switch, the second switch in electrical communication with the second battery;
turning on the first switch and the second switch within a pre-determined time;
determining whether the first battery is operational;
determining whether the second battery is operational;
allowing the first battery and second battery to remain operational if the first battery and the second battery are both operational;
discontinuing operation of the first battery and the second battery if the second battery is not operational and the pre-determined period of time has lapsed; and
determining whether the second battery is operational if the pre-determined time period has not lapsed.

13. The method of claim 12 further comprising if the first battery and second battery are each operational monitoring the State of Charge (SOC) of the first battery and the second battery.

14. The method of claim 13 further comprising if the SOC of either the first battery and the second battery are below a predetermined charge amount, discontinuing electricity to a hotel load of the electrical equipment of the locomotive.

15. The method of claim 14 further comprising starting the starter of the diesel engine.

16. The method of claim 12, wherein the predetermined time is within 60 seconds.

17. The method of claim 12 further comprising performing nine or more jogging operations per day.

18. The method of claim 17, wherein during the jogging operation, the diesel engine is not operated.

19. The method of claim 12, wherein first battery and the second battery supply power to the locomotive.

20. The method of claim 12, wherein the at least one HMI includes a first HMI associated with the first battery and a second HMI associated with the second battery.
